(19) United States
(12) Patent Application Publication
(10) Pub. No.: US 2006/0284895 A1
(43) Pub. Date: Dec. 21, 2006

(54) Dynamic gamma correction

(76) Inventors: Gabriel G. Marcu, San Jose, CA (US); John Z. Zhong, Cupertino, CA (US); Steve Swen, Cupertino, CA (US)

Correspondence Address: FISH & RICHARDSON P.C., PO BOX 1022, MINNEAPOLIS, MN, 55440-1022, US

(21) Appl. No.: 11/153,959

(22) Filed: Jun. 15, 2005

(51) Int. Cl. G09G 5/10

(52) U.S. Cl. 345/690

(57) ABSTRACT

Systems and methods for providing dynamic gamma correction are provided. In one implementation, a method for automatically adjusting a gamma correction of a display is provided. The method includes receiving an input signal from a sensor. The input signal indicates an amount of ambient light intensity. The method also includes identifying a gamma correction associated with the received input signal and changing the gamma correction of the display using the identified gamma correction.

### BACKGROUND

The present invention relates to display systems.

Conventional display devices can distort an intensity and hue of displayed images. One form of distortion is caused by an intrinsic property of a display device resulting in a nonlinear relationship between, for example, an input intensity for a pixel and an output voltage applied to the display for that pixel. Typically, the relationship between the input intensity and the response of the display device is defined by a power function. For example, in a particular display device having a transfer function expressed as a 2.5 power function, a pixel with an input intensity value of Y will produce a response (i.e., a corresponding intensity) of Y^{2.5}. Intensity values provided to the display device can have a normalized range between 0 and 1, thus, the power function can result in a displayed intensity that is less than the intended intensity. For example, for a display device having a transfer function expressed as a 2.5 power function, if an input signal indicates a pixel intensity value of 0.5, the display device will display the pixel with an intensity of only 0.177.

In addition to a distortion of pixel intensity, the power function relationship between input and output intensity also can result in a distortion of displayed hue. The degree of hue distortion depends on the power function and the color space. For example, a pixel having a hue in the RGB (red, green, blue) color space can be described by a ratio between the three colors, the ratio indicating the proportion of each hue in a given pixel (e.g., 8:2:2 for 80% red, 20% green, and 20% blue). The power function can affect different color components differently, causing a variation in the ideal ratio between the three colors and therefore a distortion of hue.

The relationship between the intended intensity and the displayed intensity for a particular display is referred as the tone response curve. In the case when the transfer function can be expressed as a power law function, the relationship between the input and the output is referred as a gamma correction that is expressed, commonly, by a gamma value. A display device having a transfer function expressed as a power function of 2.5 can therefore be described as having a tone response curve or gamma value of 2.5. For convenience, the term gamma will be used throughout the specification to refer to the relationship between input intensity and displayed intensity.

Conventionally, the value of gamma can be corrected by applying a correction signal to compliment the power function for a given display in order to provide a correct display. The process is typically referred to as gamma correction. For example, for a conventional cathode ray tube (“CRT”) display in which the intrinsic properties of the device provide a gamma value of 2.5, a correction signal can be applied to the input signal for the display that counters the effect of the gamma produced by the CRT. Thus, a gamma value of 2.5 can be cancelled out by raising the power of the input signal by 1/2.5, resulting in a gamma value of 1.

Typically, the gamma value is corrected to a value other than 1 in order to provide a correct image perception. For example, different gamma correction values can provide a perceived correct intensity and hue depending upon different ambient light conditions due to properties of human visual perception. For example, in a brightly lit environment (e.g., a high ambient light intensity), images displayed with a gamma correction of 1.8 are typically perceived as correct. However, in dimly lit environments (e.g., a low ambient light intensity), a gamma correction of 2.2 is typically perceived as correct. Some conventional devices allow manually setting the gamma correction. For example, a user of a computer system can manually adjust the gamma correction of a particular display device through a user interface. Additionally, some content to be displayed (e.g., a movie DVD) can include an encoded gamma correction to be applied that overrides any other gamma value settings.

### SUMMARY

Systems and methods for providing dynamic gamma correction are provided. In general, in one aspect, a method for automatically adjusting a gamma correction of a display is provided. The method includes receiving an input signal from a sensor. The input signal indicates an amount of ambient light intensity. The method also includes identifying a gamma correction associated with the received input signal and changing the gamma correction of the display using the identified gamma correction.

Advantageous implementations of the invention can include one or more of the following features. Identifying a gamma correction associated with the received input signal can further include converting the received input signal to identify an ambient light intensity. The method can further include determining whether one or more threshold conditions have been met based on the input signal and adjusting the gamma correction if the threshold conditions have been met. One of the threshold conditions can be determining whether a change in ambient light intensity exceeds a predetermined amount. Another one of the threshold conditions can be determining whether a change in ambient light intensity persists for a predetermined length of time.

Identifying the gamma value associated with the received input signal can further include evaluating the received input signal with one or more pre-defined functions or one or more tables relating ambient light intensity and gamma correction. Changing the gamma correction of the display can further include selecting a display profile for the identified gamma correction or retrieving one or more look-up tables for the identified gamma correction. Changing the gamma correction of the display can further include applying a gamma correction to a graphics signal output to the display or applying a correction to one or more color component values within a graphics signal according to the identified gamma correction. The method can further include setting an initial gamma correction for the display. The initial gamma correction can be set according to an initially detected ambient light intensity. The method can further include overriding any gamma correction previously encoded into graphical content to be displayed.

In general, in one aspect, a system for automatically changing a gamma correction of a display is provided. The system includes a sensor, one or more processors operable to determine a gamma correction associated with an ambient light intensity detected by the sensor, and a display operable to receive a graphics signal having a gamma correction.

Advantageous implementations of the invention can include one or more of the following features. The sensor can signal the one or more processors when a change in ambient light intensity is detected. The sensor can substantially continuously signals the one or more processors with a detected amount of ambient light intensity. The one or more processors include a processor for identifying an amount of ambient light intensity detected by the sensor. The system can further include a memory, the memory including data associating ambient light intensities with gamma correction. The one or more processors can include a graphics processor for applying the gamma correction to the graphics signal.

In general, in another aspect, an apparatus for automatically changing a gamma correction of a display is provided. The apparatus includes means for determining an amount of ambient light intensity and means for determining a gamma correction associated with the determined amount of ambient light intensity. The apparatus also includes means for applying the gamma correction to a graphics signal to be displayed; and a display for displaying a graphics input having the gamma correction.

Advantageous implementations of the invention can include one or more of the following features. The means for determining an amount of ambient light intensity can further include means for detecting ambient light intensity and means for signaling a change in the ambient light intensity. The apparatus can further include means for determining whether the amount of ambient light intensity satisfies one or more threshold conditions.

In general, in one aspect, a computer program product, tangibly stored on a computer-readable medium, for automatically adjusting a gamma correction of a display is provided. The computer program product comprises instructions operable to cause a programmable processor to receive an input signal from a sensor, the input signal indicating an amount of ambient light intensity, identify a gamma correction associated with the received input signal, and change the gamma correction of the display using the identified gamma correction.

The invention can be implemented to realize one or more of the following advantages. A gamma correction for a display can be changed automatically according to the detected ambient light intensity surrounding the display. The corrected gamma value can be used to correct a display under particular ambient lighting conditions in order to provide an optimal user perception of intensity and hue. The gamma correction can be dynamically adjusted as the ambient light intensity changes. A computing device can identify an appropriate gamma correction based on the ambient light detected by a light sensor. The automatically corrected gamma can improve contrast and image quality in different operating environments. An ambient light sensor can be used to provide information about the light environment in which the display is being viewed to a computing device for automatically correcting gamma. The gamma value identified for a particular ambient light intensity can be used to override encoded gamma correction in particular content. Thus, user intervention can be minimized while optimizing image quality relative to the viewing environment.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a block diagram of a computing system including an ambient light sensor.

FIG. 2 is a flowchart of a method for gamma correction.

FIG. 3 is a graph of gamma correction versus ambient light intensity.

FIG. 4 is a graph of gamma correction versus ambient light intensity.

FIG. 5 is a block diagram of an alternative computing system including an ambient light sensor.

Like reference numbers and designations in the various drawings indicate like elements.

### DETAILED DESCRIPTION

Overview

Systems and methods are disclosed for providing dynamic gamma correction. A sensor can detect an ambient light intensity of an environment. The sensor can then signal the detected ambient light intensity to a computing device for processing. The computing device can process the received signal from the sensor in order to determine the ambient light intensity and identify a gamma correction associated with the ambient light intensity. Once a gamma correction is identified for the ambient light intensity, the computing device can determine an appropriate gamma correction to apply to a graphics signal transmitted to a display device. The corrected graphics signal is then displayed as graphics including, for example, images, text, or other content on the display device. As the ambient light intensity changes, the computing device dynamically adjusts the gamma correction applied.

Structure

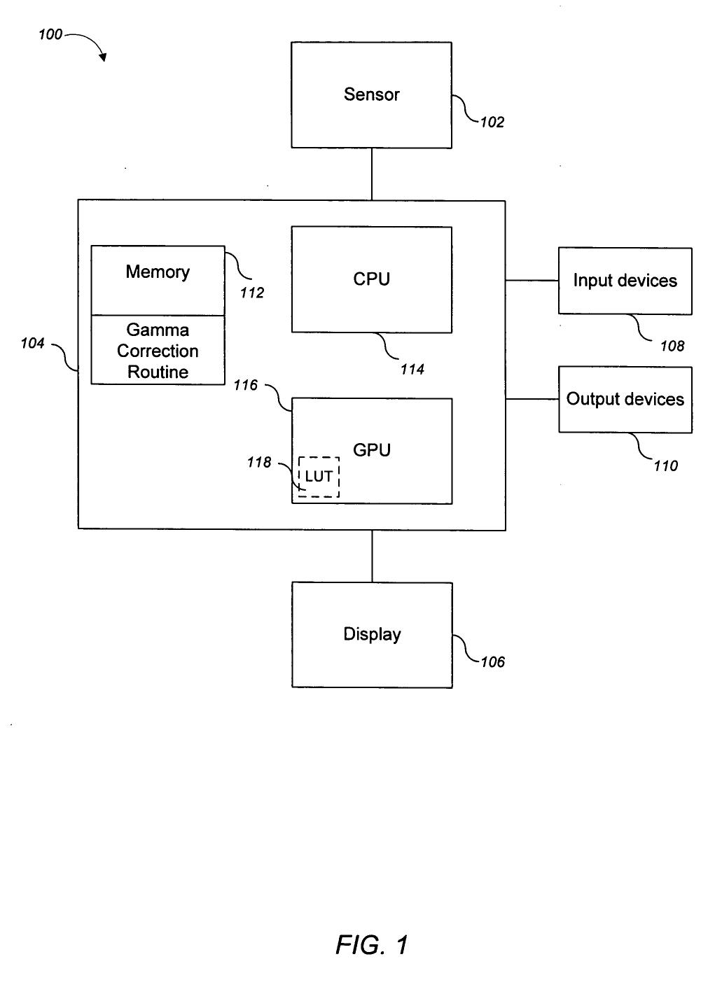

FIG. 1 shows a block diagram of one example computing system 100 for providing dynamic gamma correction. The computing system 100 includes a sensor 102 (e.g., a light sensor), a computing device 104, a display 106, input devices 108, and output devices 110. The computing device 104 includes a memory 112, a central processing unit (“CPU”) 114, and a graphics processing unit (“GPU”) 116. The GPU 116 optionally includes one or more look up tables (“LUTs”) 118 for applying a particular gamma correction to a graphics signal.

The sensor 102 can monitor an intensity of ambient light. The sensor 102 can be included within the computing device 104, for example, within a housing of a notebook computer. For example, the sensor 102 can be mounted within the housing of a notebook computer having one or more holes in the surface of the case such that the sensor 102 can detect ambient light levels of the surrounding environment. Alternatively, in another implementation, the sensor 102 can be coupled to a computing device 104, for example, using a USB connection or other interface.

In one implementation, the sensor 102 is a photodetector operable to convert detected light into an electrical signal. The electrical signal can be an analog voltage. The voltage level can correspond to different values of ambient light. In one implementation, the photodetector provides a voltage signal that is proportional to the detected ambient light intensity. In another implementation the signal can be a digital pulse indicating the light intensity detected by the sensor 102. For example, a signal generator can be coupled to the photodetector in the sensor 102 in order to generate a digital signal in response to input from the photodetector. The signal can be transmitted to the computing device 104 for processing.

The sensor 102 can be operated to detect the ambient light intensity substantially continuously or periodically. In one implementation, the sensor 102 substantially continuously converts received light into an electrical signal that is transmitted to the computing device 104. In another implementation, the computing device 104 can signal the sensor 102 to provide a periodic signal based on the then currently detected ambient light intensity. For example, the sensor 102 can detect the ambient light intensity every five seconds. Alternatively, the sensor 102 can include a signaling device that transmits a signal, indicating the ambient light intensity, at particular periodic intervals without requiring signals by computing device 104.

In another implementation, the sensor 102 transmits a signal to the computing device 104 when a change in ambient light is detected. For example, after an initial ambient light intensity is detected and signaled (e.g., to set an initial gamma correction for the display), the sensor 102 can monitor the received light and then signal the computing device 104 once a change in ambient light intensity is detected. In one implementation, the change in ambient light must exceed some threshold in order to trigger a signal from the sensor 102 to the computing device 104. For example, if the sensor 102 also includes a signaling device, the signaling device can identify whether the change in light intensity meets the threshold requirement. In one implementation, the ambient light intensity must change (e.g., increase or decrease) by at least ten percent in order to trigger a signal to the computing device 104. Threshold levels other than ten percent can be used. The threshold levels can be fixed or user adjustable.

In another implementation, a change in ambient light intensity is not signaled unless change in ambient light intensity persists for a threshold period of time. Thus, the change in ambient light intensity has to be sustained for a threshold period of time in order for the sensor 102 to signal the computing device 104. A threshold time can be used to prevent frequent adjustments to the gamma correction based on transient changes in ambient light intensity. For example, in one implementation, the change in ambient light intensity must be sustained for at least two seconds before the sensor 102 transmits a signal to the computing device 104. Alternatively, longer or shorter threshold periods can be used, including a threshold period of zero. The different threshold conditions can be implemented individually or together.

In one implementation, the sensor 102 can be enabled or disabled. For example, a user of the computing device 104 can enable or disable the sensor 102 in order to prevent any changes in gamma correction based on ambient light intensity. In one implementation, the sensor 102 can send signals to the computing device 104 only when enable.

The computing device 104 can be a number of different computing devices that are capable of controlling the gamma correction of a display device. For example, the computing device 104 can be a computer, a notebook computer or other portable computing device including a personal data assistant as well as any other suitable consumer electronics device. Additionally, the computing device 104 can be a portable device such as a personal digital player (e.g., audio, video, video game) or a mobile phone. The computing device 104 includes memory 112 that can store information including predefined gamma distribution curves, tables, and display profiles for providing gamma correction. The memory 112 can also include data describing the properties of the display 106 such as the intrinsic hardware gamma and any hardware gamma correction provided by the display 106 to any input graphics signal. The data stored in the memory 112 can be used by the CPU 114 or GPU 116 in coordination with incoming signals from the sensor 102. The data stored in the memory 112 can be retrieved and/or stored remotely. The memory 112 can include flash memory, a hard disk drive, or other data storage media.

The CPU 114 can be a processor for executing program instructions that are operable to initially process incoming signals from the sensor 102. For example, a gamma correction routine stored in memory 112 can be executed by CPU 114 to correct signals to be displayed on the display 106. The CPU 114 can process the signals received from the light sensor 102 to identify a gamma correction associated with the detected ambient light intensity. The CPU 114 can use data stored in the memory 112 to determine the intensity of the ambient light and identify the gamma correction that should be provided by the display 106 for the particular ambient light intensity. In one implementation, the CPU 114 transmits the identified gamma correction to the GPU 118. The GPU 118 can then apply an appropriate gamma correction signal (including modifying a previous gamma correction signal) to a graphics signal transmitted to the display 106. The graphics signal can include images, text, or other content to be displayed by the display 106. The GPU 118 can identify a different correction value necessary for each hue represented in the graphics signal. The correction signal is applied such that the gamma correction of the content shown by the display 106 is substantially equal to the gamma correction identified by the CPU 114 for the detected ambient light intensity.

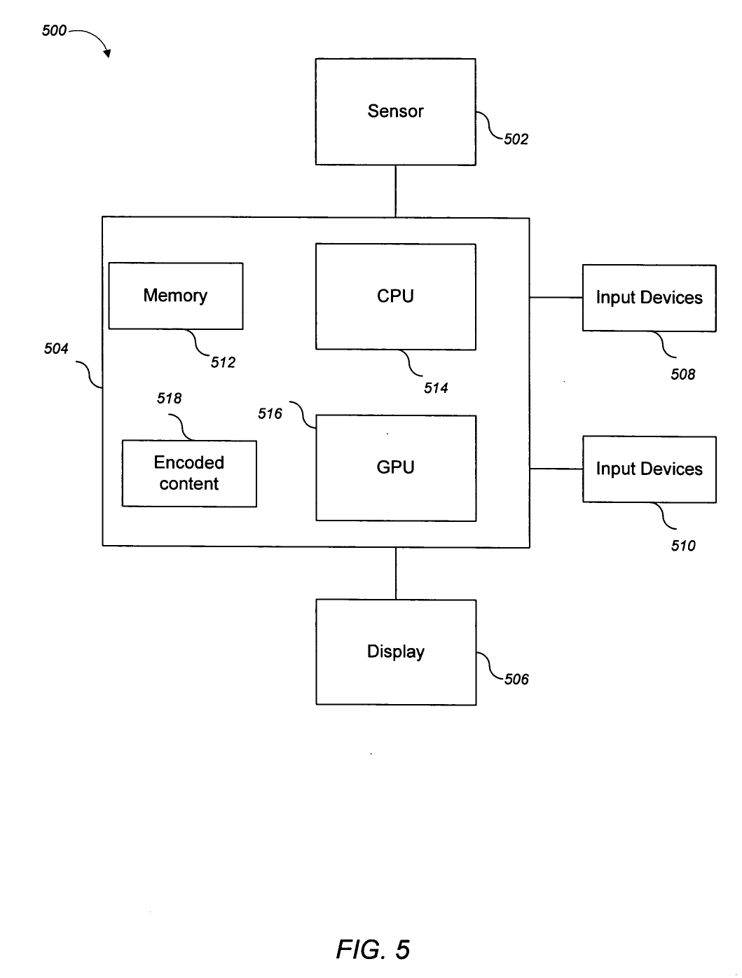

In other implementations, the configuration of components in the computing device 104 can be different. For example, in one implementation, the functions of the CPU 114 and the GPU 116 can be performed by a single processor. In one implementation the computing device 104 includes a video card that includes or works with the GPU 116. The video card can generate the graphics signal to be transmitted to the display 106 based on the content data to be displayed. In one implementation, the video card includes memory for storing gamma correction data such as look up tables for providing particular gamma correction to the graphics signal. In another implementation, the computing device 104 can include components for providing content having an encoded gamma correction, for example, a DVD player as shown in FIG. 5 below.

Input devices 108 can include, for example, a keyboard, a mouse, a pen input, a touch screen, other computing devices, or other input devices operable to transmit data to the computing device 104. In one implementation, one or more of the input devices 108 can be integrated into the computing device 104 (e.g., a keyboard of a notebook computer). Output devices can include a printer, a fax, network adaptor, or other device operable to transmit data from the computing device 104.

The display 106 can be a number of different display devices. Each display can be operable to provide visual content to a user including text, graphics, or a combination of both. For example, the display 106 can be a CRT monitor, a liquid crystal display (“LCD”), a plasma display, or some other display hardware. The display 106 can have an intrinsic gamma. Additionally, the display 106 can include a hardware gamma correction applied to any input signal. In one implementation, the display 106 receives an input signal from the computing device 104, for example, from GPU 118. The received input can include a graphics signal defining data to be displayed including text, graphics, or other content. The data can include intensity and hue information for the data to be displayed. The display 106 then renders content according to the received graphics signal (e.g., from the GPU 118). In one implementation, the data includes a gamma correction applied to the graphics signal.

Operation

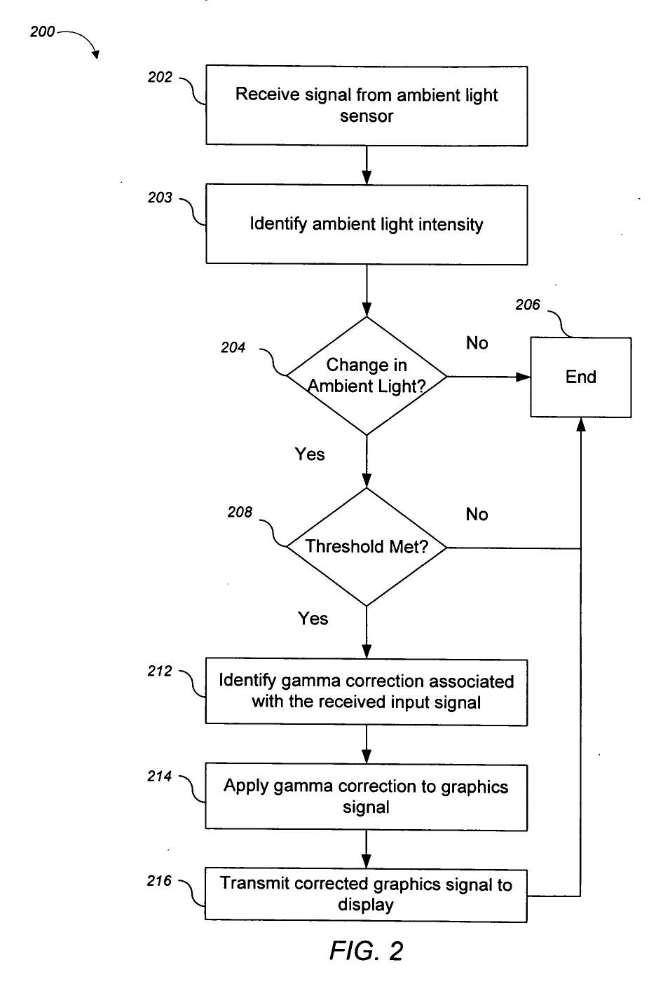

FIG. 2 shows a process 200 for dynamically adjusting a gamma correction for displayed content (e.g., by display 106) in response to a change in ambient light intensity. A signal is received from a sensor (e.g., sensor 102) (step 202). The signal can indicate a light level or alternatively a change in ambient light intensity. For example, the signal can be a voltage signal indicative of the intensity of the ambient light detected by a light sensor. In an alternative implementation, the signal can be a digital signal from light sensor indicating an ambient light intensity, a change in ambient light intensity, or an amount of increase or decrease in ambient light intensity. The signal is transmitted by the sensor and received by a computing device (e.g., computing device 104). In one implementation, the signal from the sensor is received by a processor in the computing device (e.g., CPU 114).

A determination is made (e.g., by computing device 104) of the ambient light intensity of the external environment based on the received signal (step 203). For example, in an implementation in which the received signal is an analog voltage signal proportional to the light detected by a photodetector, the ambient light intensity can be determined by comparing the received voltage signal with a table relating voltage signals to light intensity. Alternatively, for a digital pulse signal, the pulse information can be translated into a particular light intensity value according to a table or other decoding means.

A determination is made whether or not the received signal (e.g., from the sensor) indicates a change in ambient light (step 204). If there is no change in the ambient light intensity, the process ends (step 206). For example, in one implementation a sensor sends a periodic signal to a processor. The received signal, therefore, may not indicate a change in ambient light intensity meaning that no change to the gamma correction is required. In another implementation, a substantially continuous signal is received from the sensor. As a result, the processor determines whether or not an incoming signal indicates a change in ambient light. In one implementation, the incoming signal (or the decoded ambient light intensity) is compared to a previously received ambient light intensity in order to determine whether or not a change has occurred.

Alternatively, in one implementation, the sensor signals the processor when a change in ambient light intensity has been detected. The processor can verify that the received signal indicated a change in ambient light intensity. Again, for example, the processor can verify a change by comparing the light intensity of a purported change signal with a previously received signal (e.g., light intensity).

If a determination is made that there has been a change in ambient light intensity, then a check of one or more threshold conditions is made (step 208). In one implementation, a processor determines whether or not the change in ambient light exceeds a threshold value. For example, if the signal from the sensor does not indicate a change in the ambient light intensity of at least ten percent then the threshold conditions have not been met. Alternatively, the threshold for an amount of change in ambient light intensity can be based on an absolute change instead of a proportional change.

In another implementation, a determination is made to check whether the change in ambient light has persisted for a threshold length of time. For example, in an implementation in which the ambient light intensity is signaled substantially continuously, the processor does not initiate a gamma correction response unless the substantially continuous signal persists in indicating the change over a predetermined time period. Alternatively, in another implementation in which the ambient light intensity is signaled only upon a detected change, the processor can wait for the threshold period of time to ensure that a subsequent signal is not received within the threshold period.

If the threshold conditions have not been satisfied, (e.g., change in ambient light intensity of less than ten percent) the gamma correction process ends (step 206). If the threshold conditions have been met, a gamma correction associated with the received signal from the sensor is identified (step 212).

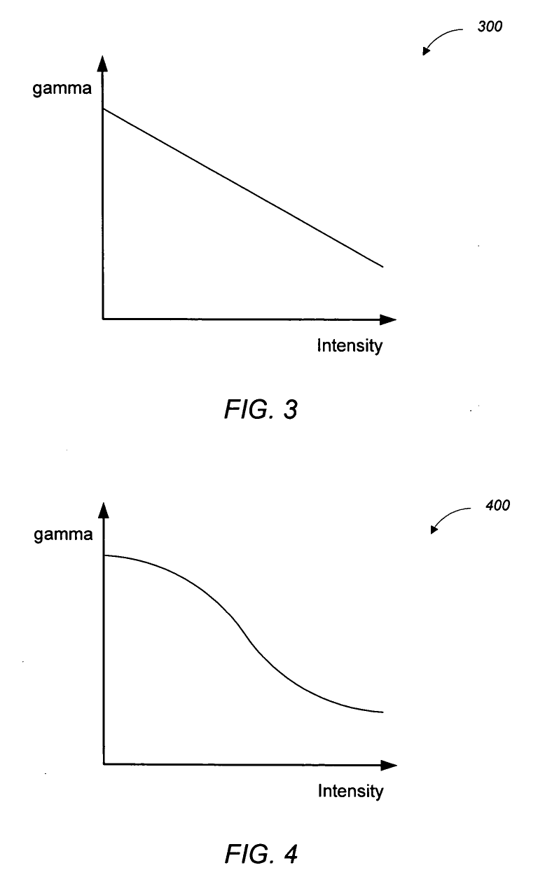

In one implementation, the processor can determine a gamma correction by associating particular values for ambient light intensity with particular gamma corrections. In one implementation, one or more tables associating discrete ambient light intensity values with particular gamma corrections can be used to determine a correct amount of gamma correction. The tables can be generated according to one or more functions relating the amount of gamma correction and ambient light intensity. The function can also be used to generate a continuous curve defining a relationship between gamma correction and ambient light intensity values. Points on the curve represent different gamma corrections associated with different ambient light intensities. The functions can be derived, for example, according to scientific studies or experimental data on visual perception at different light intensities. Example graphs showing possible relationships between ambient light intensity and gamma correction are shown in FIGS. 3 and 4.

FIG. 3 shows a graph illustrating one relationship between ambient light intensity and gamma correction. As shown in FIG. 3, a line 300 relates ambient light intensities along an x-axis with values for gamma correction along a y-axis. Therefore, for any identified ambient light intensity value, a particular amount of gamma correction can be determined based on the y-axis position of a point on the line 300 associated with the particular value of ambient light intensity. The curve 300 can be defined by a function based on known gamma correction values associated with particular ambient light intensities. For example, lower ambient light intensities can be associated with higher gamma correction values while higher ambient light intensities can be associated with lower gamma correction values. The gamma correction for other light intensities can therefore be determined according to a particular function. In FIG. 3, a linear function can be defined based on desired endpoint gamma values at particular ambient light intensities. For example, if it is known that for a particular low light intensity the gamma correction uses a gamma value of substantially 2.2 and for a high light intensity the gamma correction uses a gamma value of substantially 1.8, a linear relationship can be used to define the amount of gamma correction for all points in-between the two endpoints.

Other relationships between ambient light intensity and gamma correction can be used. For example, FIG. 4 shows a graph of ambient light intensity and gamma correction defined by a curve 400. In one implementation, the curve 400 is defined by a polynomial function. In one implementation, the curve 400 is defined such that there are smaller changes in gamma correction at the high and low ambient light intensities while the rate of change in gamma correction with ambient light intensity is greater between a minimum and maximum levels of ambient light intensity. As a result, a small change in ambient light intensity at the boundaries of the ambient light intensity will have a smaller effect on gamma correction then the same degree of change in ambient light intensity at other ambient light intensities.

Other curves can be defined based on data that identifies the gamma correction for different ambient light intensities that provide a desired user perception including other polynomial functions, exponential functions, or logarithmic functions. A step function can also be used rather then a smooth curve. For example, a step function based on the threshold value of ambient light change can be generated. One or more of the curves can be stored in memory to be used in identifying the correct gamma correction.

The processor can use the graphs, the base functions, or tables to identify the gamma correction associated with the detected ambient light intensity. In one implementation, a user can select the curve, function, or table to be used for the gamma correction process.

Once the gamma correction is identified for the detected ambient light intensity, the gamma correction is applied to a graphics signal for a display (e.g., display 106) (step 214). In one implementation, a graphics processor (e.g., GPU 116) is used to identify the gamma correction (or modification of a preexisting gamma correction) to be applied to a graphics signal such that the displayed graphics have a gamma correction based on a value equivalent to the gamma correction identified by the processor. For example, the input graphics signal for the display can be adjusted to increase or decrease the intensity for each pixel by some amount in order to provide the desired gamma correction in the displayed image.

A different amount of gamma correction can be applied to each hue component (e.g., RGB) because the hardware gamma can differ for the different color components. In one implementation, the gamma correction can be modified for each color component in order to provide a displayed hue that matches the intended hue prior to gamma correction. For example, in the RGB color system, the graphics signal includes values for the color components of a particular object (e.g., a pixel). The values occur in RGB triplets, each component having a value ranging from 0-255 in an 8-bit system. Each triplet represents a particular hue. In order to maintain the correct hue after gamma correction, the triplet values can be modified according to particular hue component's response to a change in gamma correction.

In one implementation, the graphics processor includes one or more lookup tables (“LUTs”) that provide input intensity values for each hue component (e.g., a table for red, green, and blue in an RGB system) in order to achieve a particular gamma correction. Table 1 shows an example portion of a table for determining the correct graphics signal correction for a particular hue component in which the gamma is being corrected to a value of 1.8

TABLE 1

| Input (from processor) | Output (to display) |
|---|---|
| 0 | 0 |
| 1 | 0 |
| 2 | 0 |
| 3 | 0 |
| 4 | 0 |
| 5 | 0 |
| 6 | 0 |
| 7 | 0 |
| 8 | 1 |
| 9 | 1 |
| 10 | 1 |
| 11 | 1 |
| 12 | 1 |
| 13 | 1 |
| 14 | 1 |
| 15 | 2 |
| 16 | 2 |
| 17 | 2 |
| 18 | 2 |
| 19 | 2 |
| 20 | 3 |
| 21 | 3 |
| 22 | 3 |
| . . . | . . . |

In Table 1, the first column represents the component value for the incoming graphics signal. For example, Table 1 can represent the red component of the RGB system. The values of the hue component include a range, e.g., from 0-255. For each component value, the second column provides a corresponding component value to be output to the display in order to correct for the desired (e.g., 1.8) gamma correction of the output. Different LUTs can be used for different RGB components as well as for different gamma corrections. The appropriate tables are applied to the input graphics signal to provide a corrected graphics signal to the display device. For example, Table 2 illustrates the same LUT except for a gamma correction of 2.2 instead of 1.8.

TABLE 2

| Input (from processor) | Output (to display) |
|---|---|
| 0 | 0 |
| 1 | 0 |
| 2 | 0 |
| 3 | 0 |
| 4 | 0 |
| 5 | 0 |
| 6 | 0 |
| 7 | 0 |
| 8 | 0 |
| 9 | 0 |
| 10 | 0 |
| 11 | 0 |
| 12 | 1 |
| 13 | 1 |
| 14 | 1 |
| 15 | 1 |
| 16 | 1 |
| 17 | 1 |
| 18 | 1 |
| 19 | 1 |
| 20 | 2 |
| 21 | 2 |
| 22 | 2 |
| . . . | . . . |

In one implementation, the LUTs are loaded from a display profile in memory. The ambient light intensity detected by the processor can be applied to a lookup table of display profiles to identify and apply a display profile for the display device (e.g., display 106) that is associated with the detected ambient light intensity. Examples of display profiles can be found in co-pending U.S. patent application Ser. No. 10/419,001, which is hereby incorporated by reference in its entirety. Each display profile can include a number of different parameters associated with different ambient intensities. For example, each display profile can include a set of LUTs for correcting the gamma displayed for each hue in a graphics signal. In one implementation, the display profile can also include display specific parameters that allow the display device to perform correctly. In another example, a display profile can include one or more tables used to implement the gamma correction and that are loaded into one or more videocard tables. The gamma correction can then be performed by addressing the videocard tables with the input signal and retrieving the gamma correction signal as an output of the videocard tables.

In another implementation, a user can manually select different display profiles based on their preferences or environmental conditions. The user selection can override the automatic gamma correction. In one implementation, a new display profile can be generated when there is no existing display profile matching a particular identified ambient light intensity. The gamma correction parameters of the created display profile can be interpolated from other display profiles or calculated directly.

In another implementation, the LUTs are loaded from a LUT function call. The LUTs can be generated from stored data in response to the function call. For example, once the gamma correction value is determined, the appropriate LUTs can be generated in order to apply the hue component correction to the hue value (e.g., triplets) within the graphics signal. Additionally, particular content can include LUTs associated with the data. For example, multi-media content such as a movie can include a set of LUTs to be used in applying gamma correction to that content. The graphics processor can retrieve the content specific LUTs in order to apply the gamma correction to the graphics signal.

The gamma corrected signal is then displayed by the display (step 216). The corrected graphics signal results in an output gamma correction that is substantially equal to the gamma correction identified by the processor for the ambient light intensity. The process 200 can repeat each time a new change in the ambient light intensity is detected.

In an alternative implementation, the content to be displayed is encoded incorporating a gamma correction. For example, movie content such as from a DVD can include a particular base gamma correction encoded with the movie. FIG. 5 shows a block diagram of one implementation of a system for automatically correcting a gamma value when a base gamma correction is encoded into the content to be displayed. FIG. 5 shows a system 500 that includes a sensor 502, a computing device 504, a display 506, input devices 508, and output devices 510. The computing device 504 includes a memory 512, a CPU 514, a GPU 516, and encoded content 518.

The system 500 operates similar to the system 100 (FIG. 1) with the addition of the gamma encoded content 518. The gamma encoded content 518 includes content having a predefined gamma correction specific to the content. For example, the gamma encoded content 518 can include movie content that is preset for presentation in low ambient light intensity such that the encoded gamma correction is tailored for that lighting environment. In one implementation, the computing device includes (or is) a DVD player for playing DVD movies including gamma encoded content 518. Other content can be included in the gamma encoded content 518 including graphics or image content.

In one implementation, the gamma encoded content processed by the processors in the computing device 504 (e.g., the CPU 514 or GPU 516), for transmission to the display 506, can be adjusted in view of the ambient light intensity information received from the sensor 502. For example, the CPU 514 can identify a gamma correction associated with the ambient light intensity as described above and use the identified gamma correction to override the gamma correction encoded for the gamma encoded content. Consequently, by suppressing the encoded gamma correction, the displayed content will not be corrected twice for gamma. Instead, the gamma correction of the content displayed on the display device 506 will be determined based solely on the ambient light intensity. In an alternative implementation, a user can select between applying the gamma correction of the gamma encoded content or applying the automatic gamma correction using the detected ambient light intensity.

The implementations above have been described in terms of a sensor that can detect ambient light intensity. Other environmental factors can also be considered in determining the gamma correction. For example, the particular optical characteristics of a user may require adjustments to the automatic gamma correction. In one implementation, the user can input one or more modification parameters allowing the automatic gamma correction to proceed in light of the particular viewing needs of the user. Additionally, subjective factors related to user preference may affect the settings of the gamma correction for higher or lower light intensity viewing environment such that the limits in which the gamma correction is allowed to vary can be customized to match the particular subjective user preferences. Once a range of values for the gamma correction is set, the system can automatically alter the gamma correction to optimize the displayed image quality relative to the viewing environment conditions. In one implementation, the gamma correction settings can be set for the particular user profile so that different users can have different gamma correction settings and the system can switch between different user profiles.

The invention and all of the functional operations described herein can be implemented in digital electronic circuitry, or in computer hardware, firmware, software, or in combinations of them. The invention can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments. Other embodiments are within the scope of the following claims. For example, the steps of the invention can be performed in a different order and still achieve desirable results. In addition, the invention can be implemented in any mobile system that includes a display. In particular in cell phones, media players, games consoles or game boxes, or any device that displays colors in different viewing environments.

What is claimed is:

1. A method for automatically adjusting a gamma correction of a display, comprising:
receiving an input signal from a sensor, the input signal indicating an amount of ambient light intensity;
identifying a gamma correction associated with the received input signal; and
changing the gamma correction of the display using the identified gamma correction.

2. The method of claim 1, where identifying a gamma correction associated with the received input signal further comprises:
converting the received input signal to identify an ambient light intensity.

3. The method of claim 1, further comprising:
determining whether one or more threshold conditions have been met based on the input signal; and
adjusting the gamma correction if the threshold conditions have been met.

4. The method of claim 3, where one of the threshold conditions is determining whether a change in ambient light intensity exceeds a predetermined amount.

5. The method of claim 3, where one of the threshold conditions is determining whether a change in ambient light intensity persists for a predetermined length of time.

6. The method of claim 1, where identifying the gamma value associated with the received input signal further comprises:
evaluating the received input signal with one or more pre-defined functions.

7. The method of claim 1, where identifying the gamma correction associated with the received input signal further comprises:
evaluating the received input signal with one or more tables relating ambient light intensity and gamma correction.

8. The method of claim 1, where changing the gamma correction of the display further comprises:
selecting a display profile for the identified gamma correction.

9. The method of claim 1, where changing the gamma correction of the display further comprises:
retrieving one or more look-up tables for the identified gamma correction.

10. The method of claim 1, where changing the gamma correction of the display further comprises:
applying a gamma correction to a graphics signal output to the display.

11. The method of claim 1, where changing correcting the gamma correction of the display further comprises:
applying a correction to one or more color component values within a graphics signal according to the identified gamma correction.

12. The method of claim 1, further comprising:
setting an initial gamma correction for the display.

13. The method of claim 12, where the initial gamma correction is set according to an initially detected ambient light intensity.

14. The method of claim 1, further comprising:
overriding any gamma correction previously encoded into graphical content to be displayed.

15. A system for automatically changing a gamma correction of a display, comprising:
a sensor;
one or more processors operable to determine a gamma correction associated with an ambient light intensity detected by the sensor; and
a display operable to receive a graphics signal having a gamma correction.

16. The system of claim 15, where the sensor signals the one or more processors when a change in ambient light intensity is detected.

17. The system of claim 15, where the sensor substantially continuously signals the one or more processors with a detected amount of ambient light intensity.

18. The system of claim 15, where the one or more processors include a processor for identifying an amount of ambient light intensity detected by the sensor.

19. The system of claim 15, further comprising a memory, the memory including data associating ambient light intensities with gamma correction.

20. The system of claim 15, where the one or more processors include a graphics processor for applying the gamma correction to the graphics signal.

21. An apparatus for automatically changing a gamma correction of a display, comprising:
means for determining an amount of ambient light intensity;
means for determining a gamma correction associated with the determined amount of ambient light intensity;
means for applying the gamma correction to a graphics signal to be displayed; and
a display for displaying a graphics input having the gamma correction.

22. The apparatus of claim 21, where the means for determining an amount of ambient light intensity further comprises:
means for detecting ambient light intensity; and
means for signaling a change in the ambient light intensity.

23. The apparatus of claim 21, further comprising:
means for determining whether the amount of ambient light intensity satisfies one or more threshold conditions.

24. A computer program product, tangibly stored on a computer-readable medium, for automatically adjusting a gamma correction of a display, comprising instructions operable to cause a programmable processor to:
receive an input signal from a sensor, the input signal indicating an amount of ambient light intensity;
identify a gamma correction associated with the received input signal; and
change the gamma correction of the display using the identified gamma correction.

25. The computer program product of claim 24, where the instructions to identify a gamma correction associated with the received input signal further comprise instructions to:
convert the received input signal to identify an ambient light intensity.

26. The computer program product of claim 24, further comprising instructions to:
determine whether one or more threshold conditions have been met based on the input signal; and
change the gamma correction if the conditions have been met.

27. The computer program product of claim 24, where the instructions to identify the gamma correction associated with the received input signal further comprise instructions to:
evaluate the received input signal with one or more pre-defined functions.

28. The computer program product of claim 24, where the instructions to identify the gamma correction associated with the received input signal further comprise instructions to:
evaluate the received input signal with one or more tables relating ambient light intensity and gamma correction.

29. The computer program product of claim 24, where the instructions to change the gamma correction of the display further comprise instructions to:
apply a gamma correction to a graphics signal output to the display.

30. The computer program product of claim 24, where the instructions to change the gamma correction of the display further comprise instructions to:
apply a correction to one or more color component values within a graphics signal according to the identified gamma correction.

31. A method for automatically adjusting a display, comprising:
receiving an input signal from a sensor, the input signal indicating an amount of light detected by the sensor; and
changing a gamma correction of the display using the identified gamma correction.

32. A method for automatically adjusting a display, comprising:
identifying a gamma correction associated with an ambient light intensity of an input signal from a sensor; and
modifying a gamma correction of a display using the identified gamma correction.
